(19) United States
(12) Patent Application Publication
(10) Pub. No.: US 2005/0041426 A1
(43) Pub. Date: Feb. 24, 2005

(54) Multi type electrodeless lamp

(75) Inventor: Jae-Kyu Yoo, Daegu (KR)

Correspondence Address: OSTROLENK FABER GERB & SOFFEN, 1180 AVENUE OF THE AMERICAS, NEW YORK, NY, 100368403, US

(73) Assignee: LG ELECTRONICS INC.

(21) Appl. No.: 10/753,137

(22) Filed: Jan. 7, 2004

(30) Foreign Application Priority Data
Aug. 22, 2003 (KR) 58375/2003

(51) Int. Cl. F21K 2/00

(52) U.S. Cl. 362/263

(57) ABSTRACT

In a multi type electrodeless lamp in accordance with the present invention including a bulb portion as a transparent material in which two filling spaces are formed therein; a stem portion formed at the exterior of the bulb portion so as to have a certain length; and gas-fills respectively injected into the filling spaces in order to generate plasma by electromagnetic energy, by mixing lights emitted from the gas-fills on a certain conditions, light having expected characteristics and color can be obtained. Accordingly, light efficiency can be improved, and lights having various characteristics and colors can be implemented.

### BACKGROUND OF THE INVENTION

1. Field of the Invention

The present invention relates to a multi type electrodeless lamp, and in particular to a multi type electrodeless lamp capable of implementing lights having various characteristics and colors.

2. Description of the Related Art

In general, an electrodeless lighting apparatus illuminates the surroundings with light generated from plasma by exciting gas filled in an electrodeless lamp so as to be converted into a plasma state. Because light generated by the plasma is natural light, it has better lighting efficiency than that of an incandescent electric lamp or a fluorescent lamp, in addition, it has long life span.

FIG. 1 is a sectional view illustrating a general electrodeless lighting apparatus. As depicted in FIG. 1, the electrodeless lighting apparatus includes a casing 10; a high voltage generating means 20 installed in the casing 10 in order to generate a high voltage; a magnetron 30 installed in the casing 10 in order to generate electromagnetic waves with the high voltage generated by the high voltage generating means 20; a waveguide 40 for guiding electromagnetic waves generated by the magnetron 30; a resonator 50 installed on the external front of the casing 10 in order to generate high intensity electromagnetic energy by exciting the electromagnetic waves through the waveguide 40; an electrodeless lamp 60 rotatably installed in the resonator 50 in order to generate plasma light by exciting gas-fill therein with the high intensity electromagnetic energy of the resonator 50; a mirror 70 disposed on the rear of the electrodeless lamp 60 so as to cover the electrodeless lamp 60; and a reflector 71.

And, a first driving motor 80 for rotating the electrodeless lamp 60 is installed in the casing, and a shaft 81 of the first driving motor 81 is combined with the electrodeless lamp 60.

An air duct 11 is disposed at a side of the casing 10, a fan 90 for sucking the air is installed in the air duct 11, and a second driving motor 100 for rotating the fan 90 is installed at a side of the fan 90.

The operation of the electrodeless lighting apparatus will be described.

First, when power is applied to the electrodeless lighting apparatus, the high voltage generating means 20 generates a high voltage, and the magnetron 30 oscillates electromagnetic waves by the high voltage generated in the high voltage generating means 20. The electromagnetic waves oscillated by the magnetron 30 are transmitted to the resonator 50 through the waveguide 40, and the electromagnetic waves transmitted to the resonator 50 distribute high intensity electromagnetic energy. By the high intensity electromagnetic energy distributed in the resonator 50, the gas-fill in the electrodeless lamp 60 is discharged and simultaneously gasified, and accordingly plasma occurs. Light generated while the plasma occurs in the electrodeless lamp 60 is reflected toward the front by the mirror 70 and the reflector 71.

And, by rotating the electrodeless lamp 60 by operating the first driving motor 80, intensive heating of the electrodeless lamp 60 can be prevented, and the plasma can be uniformly distributed.

The fan 90 is rotated by operating the second driving motor 100, according to the rotation of the fan 90, the air flows into the casing 10 through the air duct 11, and accordingly the high voltage generating means 20 and the magnetron 30 are cooled.

In the meantime, as depicted in FIG. 2, the electrodeless lamp 60 consists of a bulb portion 62 formed as a globular-shaped transparent material so as to have an internal filling space 61; a stem portion 63 extended-formed from a side of the bulb portion 62 so as to be connected with the shaft of the first driving motor 80; and a gas-fill filled in the filling space 61 of the bulb portion 62. The bulb portion 62 is formed as a globular shape having a certain thickness, and the stem portion 63 is formed as a round bar shape having a certain length.

In the electrodeless lamp 60, the gas-fill in the filling space 61 is excited by the electromagnetic energy formed by the resonator 50 and generates plasma, and light is emitted by the plasma. Herein, color and characteristics of light generated by the plasma can be varied according to compositions or additions of a gas-fill filled in the filling space 61. Accordingly, in order to obtain light having an expected color or characteristics, a gas-fill emitting an expected color on a certain conditions is made and is injected into the filling space 61. In addition, when two lights have to be mixed in order to obtain an expected light, each gas-fill emitting each light is respectively made, and the made two gas-fills are injected into the filling space 61. In that case, on a certain conditions, the two gas-fills emit light respectively, and light in which the two lights are added is emitted to the outside of the electrodeless lamp 60.

For example, it is assumed a gas-fill A emitting A1 light is a composition including ingredients a, b, c and a gas-fill B emitting B1 light is a composition including ingredients d, e, f, when an expected light can be obtained by adding the light A1 to the light B1, the gas-fill A and the gas-fill B are mixed-injected in the filling space 61 of the electrodeless lamp and maintained on a certain conditions, and accordingly mixed light can be emitted.

However, when gas-fills are mixed in order to emit a light in which at least two lights are mixed, the gas-fills may not be mixed due to chemical compositions thereof, and accordingly an expected light may not be emitted. Under the present circumstances in which a user's request for illuminating is verified, the user's request can not be satisfied sufficiently.

### SUMMARY OF THE INVENTION

In order to solve the above-mentioned problem, it is an object of the present invention to provide a multi type electrodeless lamp capable of implementing lights having various characteristics and colors by mixing plural lights, in particular, lights emitted from gas-fills which are not mixed with each other.

In order to achieve the above-mentioned object, a multi type electrodeless lamp in accordance with the present invention includes a bulb portion as a transparent material in which two filling spaces are formed therein; a stem portion formed at the exterior of the bulb portion so as to have a certain length; and gas-fills respectively injected into the filling spaces in order to generate plasma by electromagnetic energy.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view illustrating a general electrodeless lighting apparatus;

FIG. 2 is a partial sectional-front view illustrating an electrodeless lamp of the electrodeless lighting apparatus;

FIG. 3 is a sectional view illustrating an electrodeless lighting apparatus having an electrodeless lamp in accordance with an embodiment of the present invention;

FIG. 4 is a partial sectional-front view illustrating the electrodeless lamp;

FIG. 5 is a front view illustrating an electrodeless lamp in accordance with another embodiment of the present invention; and

FIG. 6 is a front view illustrating an electrodeless lamp in accordance with yet another embodiment of the present invention.

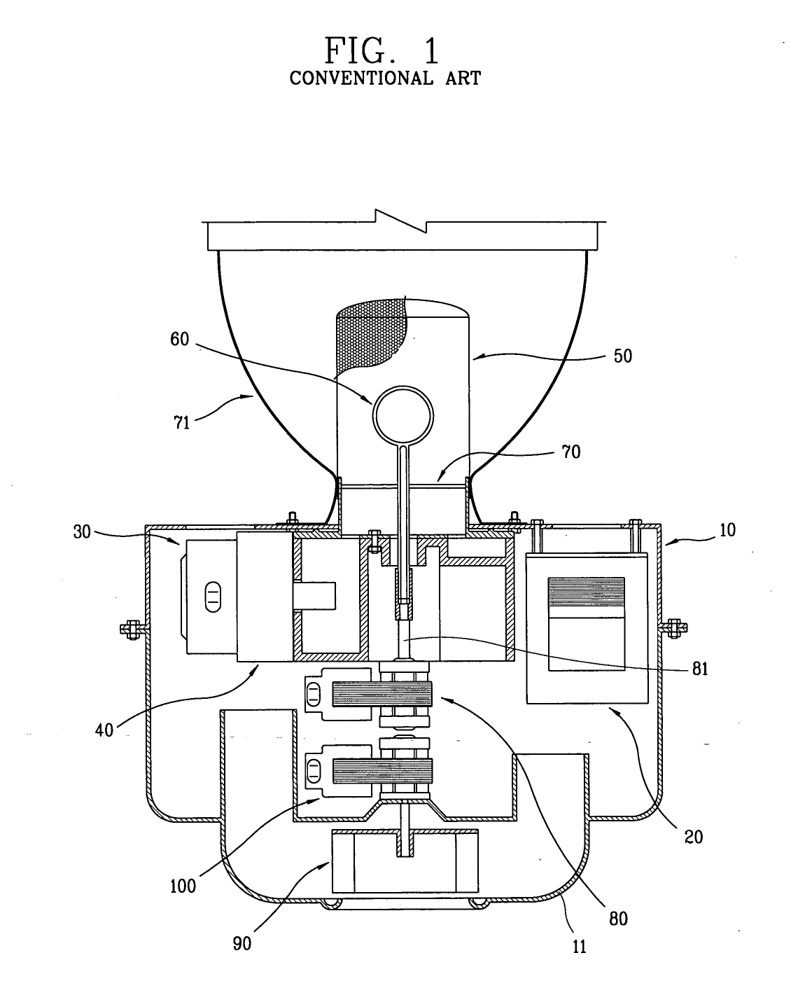

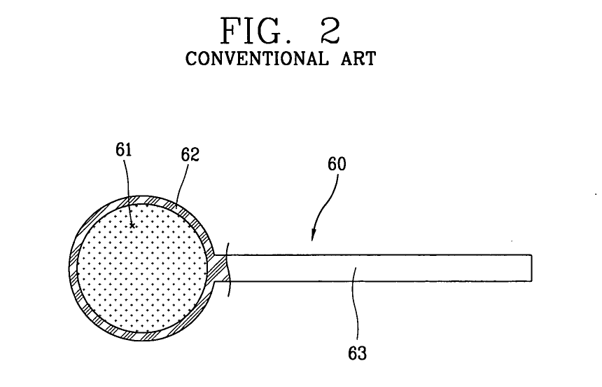

### DETAILED DESCRIPTION OF THE PREFERRED EMBODIMENT

Hereinafter, the preferred embodiments of the present invention will be described with reference to accompanying drawings.

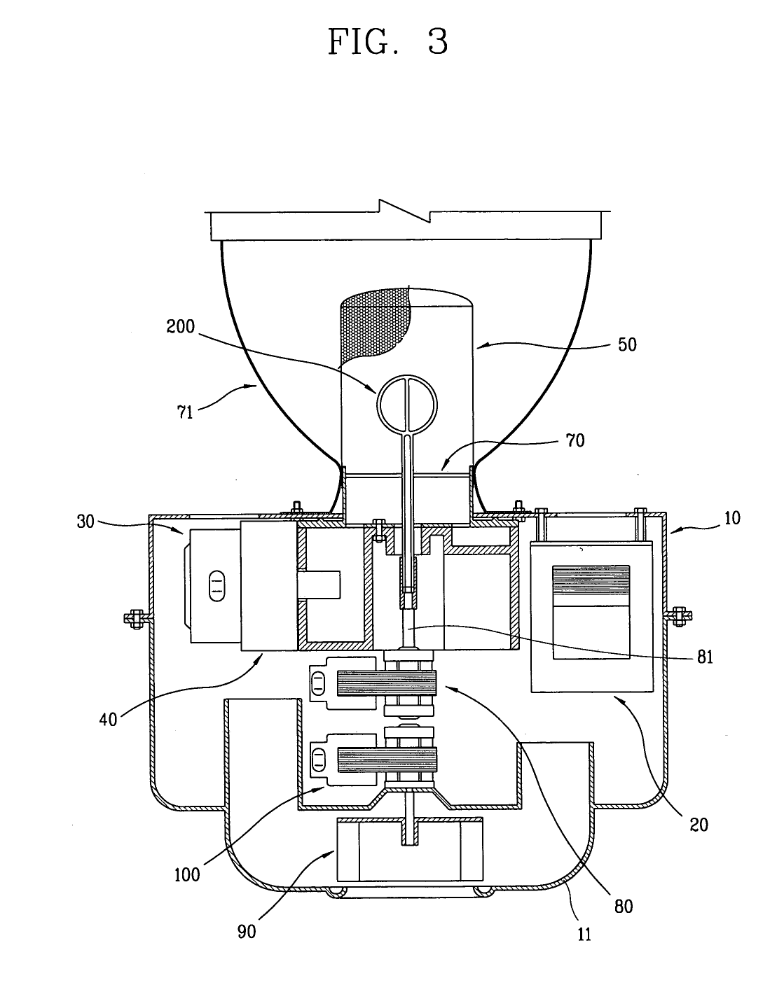

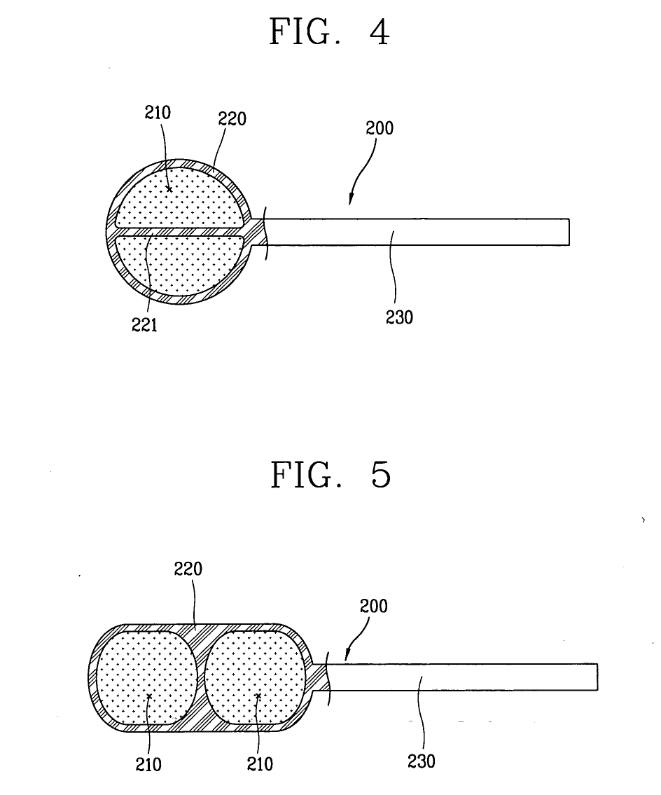

FIG. 3 is a sectional view illustrating an electrodeless lighting apparatus having an electrodeless lamp in accordance with an embodiment of the present invention, and FIG. 4 is a partial sectional-front view illustrating the electrodeless lamp. Parts same with the conventional art will have the same reference numerals.

As depicted in FIGS. 3 and 4, a construction of the electrodeless lighting apparatus apparatus having the electrodeless lamp in accordance with the embodiment of the present invention is the same with that of a general electrodeless lighting apparatus, and accordingly detailed explanation about the construction of the electrodeless lighting apparatus will be abridged.

In the electrodeless lighting apparatus in accordance with the present invention, a multi type electrodeless lamp 200 is rotatably disposed in the resonator 50 and is connected with a first driving motor 80. The multi type electrodeless lamp 200 is connected to a shaft 81 of the first driving motor directly or by an additional connecting means.

The multi type electrodeless lamp 200 in accordance with the present invention consists of a bulb portion 220 as a transparent material in which two filling spaces 210 are formed therein; a stem portion 230 formed at the exterior of the bulb portion 220 so as to have a certain length; and gas-fills respectively injected into the filling spaces 210 in order to generate plasma by electromagnetic energy.

The bulb portion 220 has a globular shape, and the stem portion 230 is extended-formed at a side of the bulb portion 220 so as to have a certain length and diameter. The bulb portion 220 has a uniform thickness, and the stem portion 230 is radially disposed to the center of the bulb portion 220.

The two filling spaces 210 are disposed so as to face each other on the basis of the stem portion 230 as a reference axis. A wall 221 for partitioning the two filling spaces 210 is formed as a plane plate, and each filling space 210 partitioned by the wall 221 has a hemispheric shape. The two filling spaces 210 have the same volume and shape. As occasion demands, the two filling spaces 210 can have a shape and a volume different from each other.

Gas-fills injected into the filling spaces 210 are different from each other. In more detail, the gas-fills are materials in which different lights are emitted from plasma when the plasma is formed on a certain conditions.

As depicted in FIG. 5, in a multi type electrodeless lamp in accordance with another embodiment of the present invention, the multi type electrodeless lamp has two filling spaces 210 in the bulb portion 220, and the two filling spaces 210 are arranged in the axial direction on the basis of the stem portion 230 as a reference axis.

The bulb portion 220 is formed as a non-globular shape, the filling spaces 210 formed therein have the same shape and volume. As occasion demands, the two filling spaces 210 can have a shape and a volume different from each other. In addition, the bulb portion 220 can be formed as a globular shape.

Gas-fills injected into the filling spaces 210 are different from each other. In more detail, the gas-fills are materials in which different lights are emitted from plasma when the plasma is formed on a certain conditions.

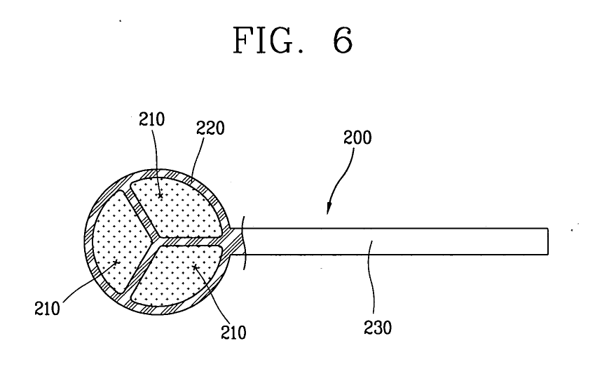

FIG. 6 is a front view illustrating an electrodeless lamp in accordance with yet another embodiment of the present invention.

As depicted in FIG. 6, the electrodeless lamp in accordance with yet another embodiment of the present invention consists of a bulb portion 220 in which at least two filling spaces 210 are formed therein; a stem portion formed at the bulb portion 220 so as to have a certain length; and gas-fills respectively injected into the filling spaces 210 so as to generate plasma by electromagnetic energy.

When three filling spaces 210 are formed in the bulb portion 220, the three filling spaces 210 partition the inside of the bulb portion 220 into three spaces. The three filling spaces 210 have the same shape and volume.

As occasion demands, the three filling spaces 210 can have a shape and a volume different from each other.

The gas-fills injected into the filling spaces 210 are different from each other. In more detail, the gas-fills are materials in which different lights are emitted from plasma when the plasma is formed on a certain conditions.

Hereinafter, the operation of the multi type electrodeless lamp in accordance with the present invention will be described.

First, when power is supplied to the electrodeless lighting apparatus, the high voltage generating means generates a high voltage, and the magnetron 30 oscillates electromagnetic waves by the high voltage generated in the high voltage generating means 20.

The electromagnetic waves oscillated in the magnetron 39 are transmitted to the resonator 50 through the waveguide 40, and the electromagnetic waves transmitted to the resonator 50 distribute high intensity electromagnetic energy inside the resonator 50.

By the high intensity electromagnetic energy distributed in the resonator 50, the gas-fill filled in each filling space 210 of the electrodeless lamp 200 is excited and gasified, and accordingly plasma is generated in each filling space 210.

Herein, because the gas-fill respectively injected into the filling space 210 is different from each other, plasma occurred in each filling space 210 emits light having characteristics and color according to those of the gas-fill injected into the filling space 210. Lights emitted from the filling spaces 210 are mixed with each other, the mixed light is reflected onto a mirror 70 and a reflector 80 and illuminates the front.

And, by the operation of the first driving motor 80, the multi type electrodeless lamp 200 is rotated, and accordingly it is possible to prevent the bulb portion 220 from being intensively heated by the plasma.

By the operation of the second driving motor 100, the fan 90 is rotated, according to the rotation of the fan 90, the air flows into the casing 10 through the air duct 11, and accordingly the high voltage generating means 20 and the magnetron 30 can be cooled.

In the meantime, the gas-fills filled in the filling spaces 210 of the multi type electrodeless lamp have characteristics emitting a reference light for constructing characteristics and color of a finally obtained light respectively. In more detail, when an expected light is a light having color and characteristics obtained by mixing a light A1 with a light B1, a gas-fill emitting the light A1 and a gas-fill emitting the light B1 are respectively injected and are maintained on a certain conditions, an expected light in which the light A1 and the light B1 are mixed is emitted.

The gas-fills injected into the filling spaces 210 of the multi type electrodeless lamp are different from each other and not mixed well with each other. Of course, gas-fills respectively injected into the filling spaces 210 can be the same and be mixed well with each other. However, in that case, meaning for constructing plural filling spaces 210 is reduced.

As described-above, in the multi type electrodeless lamp in accordance with the present invention, by forming plural filling spaces 210 inside the bulb portion 220, injecting gas-fills not mixed with each other into the filling spaces 210 respectively, lights emitted from the gas-fills are mixed, and light having expected characteristics and color can be obtained. Therefore, it is possible to improve light efficiency and implement lights having various characteristics and colors, usage range of the lamp can be increased and request of a user can be satisfied.

1. A multi type electrodeless lamp, comprising:
a bulb portion as a transparent material in which two filling spaces are formed therein;
a stem portion formed on the exterior of the bulb portion so as to have a certain length; and
gas-fills respectively injected into the filling spaces in order to generate plasma by electromagnetic energy.

2. The lamp of claim 1, wherein the filling spaces are arranged so as to face each other on the basis of the stem portion as a reference axis.

3. The lamp of claim 2, wherein a wall for partitioning the filling spaces is a plane plate.

4. The lamp of claim 2, wherein the two filling spaces have the same volume.

5. The lamp of claim 2, wherein the two filling spaces have the same shape.

6. The lamp of claim 1, wherein the two filling spaces are arranged in the axial direction on the basis of the stem portion as a reference axis.

7. The lamp of claim 6, wherein the two filling spaces have the same volume.

8. The lamp of claim 6, wherein the two filling spaces have the same shape.

9. The lamp of claim 1, wherein the bulb portion has a globular shape.

10. The lamp of claim 1, wherein the bulb portion has a non-globular shape.

11. The lamp of claim 1, wherein a composition of the gas-fill respectively injected into the filling space is different from each other.

12. A multi type electrodeless lamp, comprising:
a bulb portion as a transparent material in which at least two filling spaces are formed therein;
a stem portion formed on the bulb portion so as to have a certain length; and
gas-fills respectively injected into the filling spaces in order to generate plasma by electromagnetic energy.

13. The lamp of claim 12, wherein the number of the filling spaces is three.

14. The lamp of claim 13, wherein the three filling spaces have the same shape and volume.

15. The lamp of claim 12, wherein the three filling spaces have a shape and a volume different from each other.

16. The lamp of claim 12, wherein the gas-fill respectively injected into the filling spaces has a composition different from each other.

17. A multi type electrodeless lamp, comprising:
a bulb portion as a transparent material in which two filling spaces are formed therein; and
gas-fills respectively injected into the filling spaces in order to generate plasma by electromagnetic energy.

18. The lamp of claim 17, wherein a composition of the gas-fill respectively injected into the filling space is different from each other.
